(19) United States
(12) Patent Application Publication
(10) Pub. No.: US 2024/0363940 A1
(43) Pub. Date: Oct. 31, 2024

(54) BATTERY MODULE AND BATTERY PACK INCLUDING THE SAME

(71) Applicant: LG ENERGY SOLUTION, LTD., Seoul (KR)

(72) Inventor: Jong Chul CHOI, Daejeon (KR)

(73) Assignee: LG ENERGY SOLUTION, LTD., Seoul (KR)

(21) Appl. No.: 18/682,018

(22) PCT Filed: Nov. 7, 2022
(86) PCT No.: PCT/KR2022/017332

§ 371 Date: Feb. 7, 2024

(30) Foreign Application Priority Data
Nov. 15, 2021 (KR) 10-2021-0156325
Nov. 4, 2022 (KR) 10-2022-0145759

(51) Int. Cl. H01M 50/233; H01M 10/6554; H01M 50/213; H01M 50/227; H01M 50/231; H01M 50/244

(52) U.S. Cl. CPC H01M 50/233; H01M 10/6554; H01M 50/213; H01M 50/227; H01M 50/231; H01M 50/244

(57) ABSTRACT

A battery module according to one or more example embodiments includes a bottom plate, a cell frame located on the bottom plate, a plurality of battery cells mounted to the cell frame, and an adhesive layer located between the bottom plate and the plurality of battery cells. The cell frame has light transmittance. A battery pack including the battery module is also disclosed.

### TECHNICAL FIELD

### Cross-Reference to Related Application(s)

This application claims the benefit of Korean Patent Application No. 10-2021-0156325 filed on Nov. 15, 2021 and Korean Patent Application No. 10-2022-0145759 filed on Nov. 4, 2022 in the Korean Intellectual Property Office, the entire contents of which are incorporated herein by reference.

The present disclosure relates to a battery module and a battery pack including the same, and more particularly, to a battery module whose process time is reduced, and a battery pack including the same.

### BACKGROUND

With the technology development and increased demand for mobile devices, demand for secondary batteries as energy sources has been rapidly increasing. A variety of researches on secondary batteries capable of meeting various needs have been carried out accordingly.

A secondary battery has attracted considerable attention as an energy source for power-driven devices, such as an electric bicycle, an electric vehicle, and a hybrid electric vehicle, as well as an energy source for mobile devices, such as a mobile phone, a digital camera and a laptop computer.

Lithium secondary batteries, which are frequently used among secondary batteries, classified based on the shape of the exterior material into a can-type secondary battery in which the electrode assembly is built into a metal can, and a pouch-type secondary battery in which the electrode assembly is built into a pouch of an aluminum laminate sheet

Among them, the can-type secondary battery can manufacture a metal can for accommodating an electrode assembly in a cylindrical shape. Such a can-type secondary battery is provided with a housing that accommodates multiple secondary batteries, thereby realizing a battery module. However, when the multiple secondary batteries are accommodated in the housing inner space of the battery module without fixing means, the secondary battery is easily movable in the accommodation space inside the housing in an environment where the vehicle equipped with the battery module is subject to frequent vibrations and shocks caused by dropping, which causes problems such as damage to the secondary battery or breakage of the connection between the electrode terminal and the busbar.

### DETAILED DESCRIPTION OF THE INVENTION

### Technical Problem

It is an object of the present disclosure to provide a battery module whose process time is reduced, and a battery pack including the same.

However, the technical problem to be solved by embodiments of the present disclosure is not limited to the above-described problems, and can be variously expanded within the scope of the technical idea included in the present disclosure.

### Technical Solution

According to one aspect of the present disclosure, there is provided a battery module comprising: a bottom plate, a cell frame located on the bottom plate, a plurality of battery cells mounted to the cell frame, and an adhesive layer located between the bottom plate and the plurality of battery cells, wherein the cell frame has light transmittance.

The adhesive layer may be formed of a photocurable resin.

The cell frame may be formed with a plurality of holes for mounting the battery cells.

The adhesive layer may be formed in the plurality of holes and contacts at least one of the bottom plate and the bottom portion of the battery cell.

The cell frame may be formed of a resin that generates total internal reflection into the cell frame.

The resin may have a transmittance of 90% or more.

The battery module may further comprise a diffuse reflection member formed on a part of the surface of the cell frame.

The diffuse reflection member may be formed on a boundary surface between the cell frame and the adhesive layer.

A light that entered the cell frame passes through the diffuse reflection member and is emitted to the adhesive layer, so that the adhesive layer can be photo-cured.

The adhesive layer may include a photocuring initiator.

The bottom plate may be a cooling plate.

The battery cell may be cylindrical.

The bottom plate and the cell frame may be integrally formed.

A plurality of light paths may be formed inside the cell frame.

According to another aspect of the present disclosure, there is provided a battery pack comprising the above-mentioned battery module.

### Advantageous Effects

According to embodiments, a light-transmitting cell frame having a total reflection function and a photocurable resin are used as an adhesive, thereby capable of reducing a process time.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a diagram showing a battery module according to a comparative example;

FIG. 2 is a diagram showing a method of forming a battery module according to the comparative example of FIG. 1;

FIG. 3 is a diagram showing a battery module according to one embodiment of the present disclosure;

FIG. 4 is a plan view of the cell frame shown in FIG. 3;

FIG. 5 is a diagram showing a method of forming a battery module according to the embodiment of FIG. 3;

FIG. 6 is a diagram showing a state in which the adhesive layer of FIG. 5 is cured; and FIG. 7 is an enlarged view of region P of FIG. 6.

### DETAILED DESCRIPTION OF THE EMBODIMENTS

Hereinafter, various embodiments of the present disclosure will be described in detail with reference to the accompanying drawings so that those skilled in the art can easily carry out them. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggerated.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain part being located “above” or “on” a reference portion means the certain part being located above or below the reference portion and does not particularly mean the certain part “above” or “on” toward an opposite direction of gravity.

Further, throughout the description, when a portion is referred to as “including” or “comprising” a certain component, it means that the portion can further include other components, without excluding the other components, unless otherwise stated.

Further, throughout the description, when it is referred to as “planar”, it means when a target portion is viewed from the upper side, and when it is referred to as “cross-sectional”, it means when a target portion is viewed from the side of a cross section cut vertically.

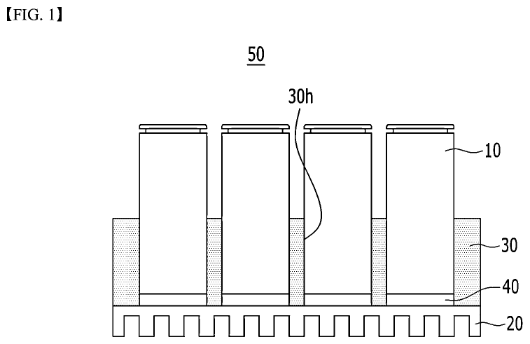

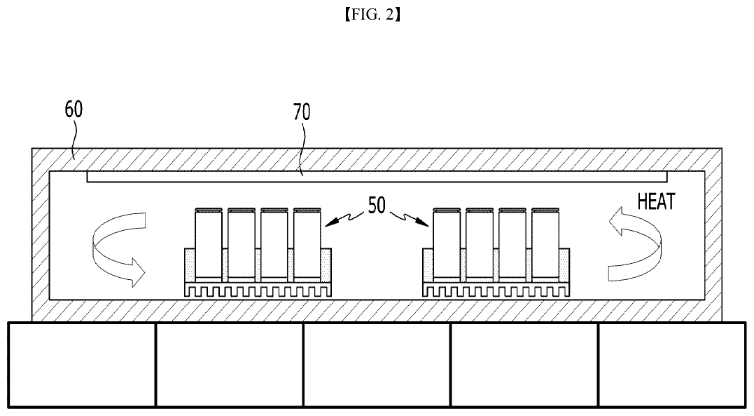

FIG. 1 is a diagram showing a battery module according to a comparative example. FIG. 2 is a diagram showing a method of forming a battery module according to the comparative example of FIG. 1.

Referring to FIG. 1, a battery module 50 according to a comparative example includes a bottom plate 20, a cell frame 30 located on the bottom plate 20, and battery cells 10 mounted in each of the plurality of holes 30h formed in the cell frame 30. At this time, in order to fix the battery cell 10 to the bottom plate 20, the fixing adhesive layer 40 may be formed inside the plurality of holes 30h.

Referring to FIG. 2, at least one battery module 50 can be disposed inside a chamber 60, and heat can be applied to the inside of the chamber 60 via a heater 70 or the like. An adhesive made of a thermosetting resin is applied to the plurality of holes 30h formed in the cell frame 30 shown in FIG. 1, and the adhesive is thermally cured to form an adhesive layer 40 shown in FIG. 1, and the battery cell 10 can be fixed to the bottom plate 20 by the adhesive layer 40. However, it may take a long process time until thermal curing is performed within the chamber 60 to form an adhesive layer 40.

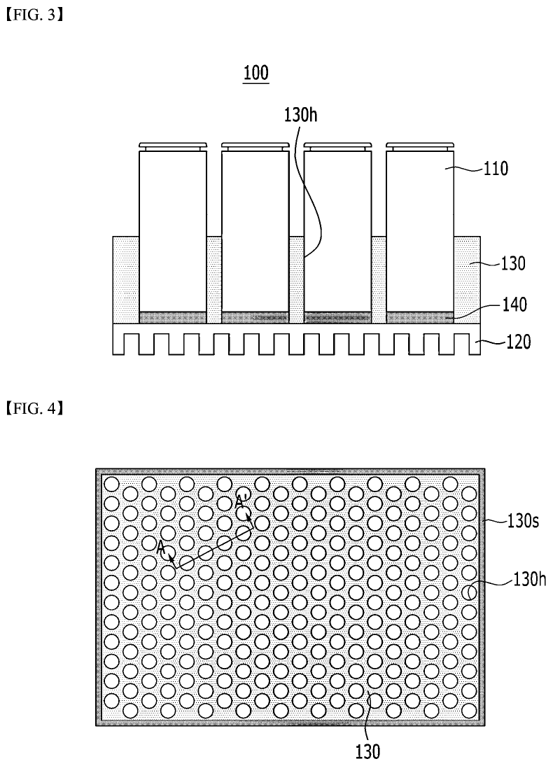

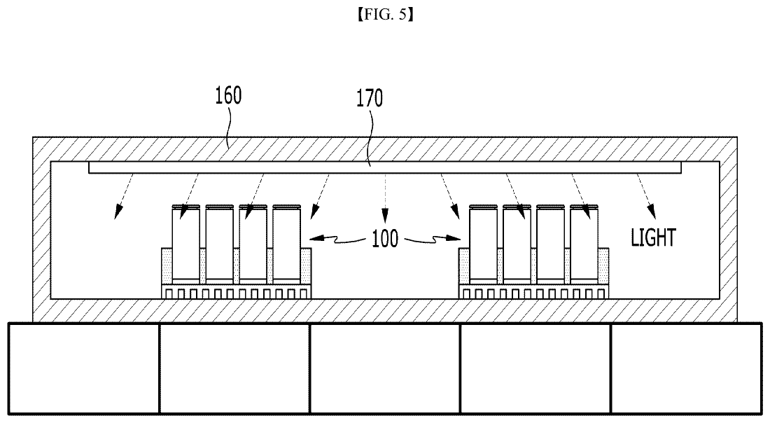

FIG. 3 is a diagram showing a battery module according to one embodiment of the present disclosure. FIG. 4 is a plan view of the cell frame shown in FIG. 3.

Referring to FIG. 3, the battery module 100 according to the present embodiment includes a bottom plate 120, a cell frame 130 located on the bottom plate 120, a plurality of battery cells 110 mounted to the cell frame 130, and an adhesive layer 140 located between the bottom plate 120 and the plurality of battery cells 110. At this time, the adhesive layer 140 may contact at least one of the bottom plate 120 and the bottom portion of the battery cell 110.

The bottom plate 120 according to the present embodiment may be a cooling plate for cooling the battery cell 110. However, the bottom plate 120 itself is not a cooling plate, but is used for supporting the cell frame 130 that accommodates the battery cells 110. A separate heat sink may be formed under the bottom plate 120.

The cell frame 130 according to the present embodiment may have light transmittance. As the cell frame 130 has light transmittance, light generated from the light source unit can pass through the cell frame 130 in a manufacturing method of the battery module 100, which will be described below. The cell frame 130 may have transparent properties. Specifically, the cell frame 130 is preferably made of a resin that generates total internal reflection into the cell frame 130. At this time, the resin may have a transmittance of 90% or more. The resin may be an injection molding resin.

Referring to FIGS. 3 and 4, a plurality of holes 130h for mounting the battery cells 110 may be formed in the cell frame 130. The adhesive layer 140 is formed in the plurality of holes 130h so as to contact the bottom plate 120 and the cell frame 130, and the battery cell 110 may be disposed on the adhesive layer 140.

The hole 130h formed in the cell frame 130 according to the present embodiment may be cylindrical, and the battery cell 110 is preferably a cylindrical cell that is suitable for mounting in the cylindrical hole 130h.

The adhesive layer 140 according to the present embodiment may be made of a photocurable resin. At this time, the photocurable resin may be made of acrylic, silicone, epoxy, and the like, and the adhesive layer 140 preferably includes a photocuring initiator. When the photocurable resin constituting the adhesive layer receives light, the adhesive layer 140 is formed while being cured by the photocuring initiator, and the battery cell 110 may be fixed to the cell frame 130 on the bottom plate 120 by the adhesive layer 140.

As shown in FIG. 4, the cell frame 130 may include a portion having holes 130h in which the plurality of battery cells 110 are mounted, and side surface frames 130s. However, the cell frame is not limited thereto, and a cell frame 130 may have a structure in which a portion having holes 130h for mounting the plurality of battery cells 110 and the side surface frames 130s are integrally formed. The battery module 100 shown in FIG. 3 may be a cross-sectional view taken along the line A-A′ of FIG. 4.

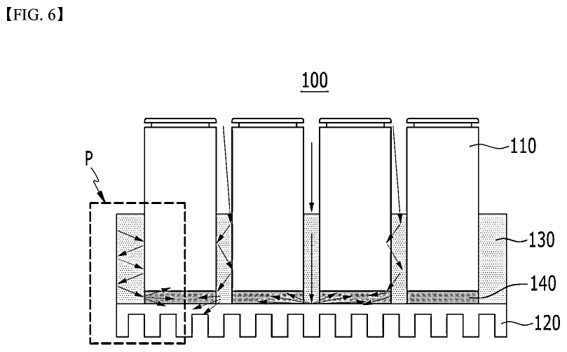

FIG. 5 is a diagram showing a method of forming a battery module according to the embodiment of FIG. 3. In FIG. 5, the battery module 100 disposed inside the chamber 160 shows only a part of the state where the plurality of battery cells 110 are mounted to the cell frame 130 for convenience of description and illustration.

Referring to FIGS. 3 and 5, at least one battery module 100 may be disposed inside the chamber 160. A light source unit 170 is formed inside the chamber 160 to irradiate at least one battery module 100 with light. The light source unit 170 is located below the upper end of the chamber 160. As the light is irradiated downward, the light may reach the cell frame 130 of the battery module 100 disposed inside the chamber 160.

The light source unit 170 according to the present embodiment may use an ultraviolet lamp or a halogen lamp.

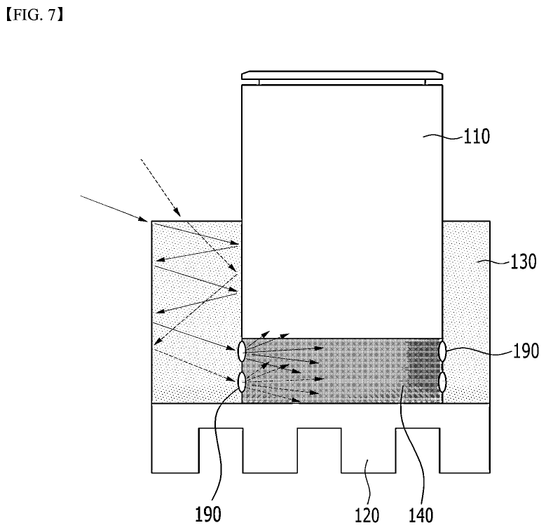

An adhesive formed of a photocurable resin is applied to the plurality of holes 130h formed in the cell frame 130, and the adhesive is photocured to thereby form the adhesive layer 140 shown in FIG. 3, and the battery cell 110 may be fixed to the bottom plate 120 by the adhesive layer 140. A process of forming the adhesive layer 140 by photocuring will be described in detail with reference to FIGS. 6 and 7.

FIG. 6 is a diagram showing a state in which the adhesive layer of FIG. 5 is cured. FIG. 7 is an enlarged view of region P of FIG. 6.

Referring to FIGS. 5 to 7, when light generated from the light source unit 170 disposed inside the chamber 160 is irradiated toward the battery module 100, light enters into the cell frame 130 having light transmittance. Light entering the cell frame 130 may have several paths.

The battery cell 110 may be a can-type secondary battery, and the electrode assembly included in the battery cell 110 may be wrapped in a case made of metal. The light that has entered the cell frame 130 is totally reflected, and may be emitted to the outside of the cell frame 130 when it encounters a diffuse reflection member 190 described below. Therefore, according to the present embodiment, light entering the cell frame 130 can be emitted at the target portion.

At this time, according to the present embodiment, as the cell frame 130 is made of a resin that generates total internal reflection into the cell frame 130, light entering the cell frame 130 can be prevented from escaping to the outside of the cell frame 130. In other words, after light enters the cell frame 130 having light transmittance, it may be totally reflected into the cell frame 130 so that it does not escape to the outside of the cell frame 130. Therefore, since the light entering the cell frame 130 is confined inside the cell frame 130, light efficiency can be increased. A resin forming the cell frame 130 may have a high refractive index compared to a medium outside the cell frame 130. In one example, the resin forming the cell frame 130 may be polymethyl methacrylate (PMMA) or polycarbonate (PC).

In this manner, in order for a plurality of light paths to be formed inside the cell frame 130 and for such light to form the adhesive layer 140, the light must be able to reach an adhesive made of a thermosetting resin applied between the battery cell 110 and the bottom plate. For this purpose, according to the present embodiment, a diffuse reflection member 190 may be formed on a part of the surface of the cell frame 130 as shown in FIG. 7. As an example of the diffuse reflection member 190, the diffuse reflection pattern 190 can be formed in various patterns that cause diffuse reflection, such as intaglios and embossments. The diffuse reflection member 190 may be formed on a boundary surface between the cell frame 130 and the adhesive layer 140. Light that entered the cell frame 130 passes through the diffuse reflection pattern 190 and is emitted to the adhesive layer 140 so that the adhesive layer 140 can be photocured.

In the present embodiment, the diffuse reflection member 190 has been described as a diffuse reflection pattern, but is not limited thereto, and the diffuse reflection member 190 may also include a case where particles are put therein to cause diffuse reflection.

The plurality of light paths formed inside the cell frame 130 may be generated by bending paths of light entering from the outside of the cell frame 130 several times inside the cell frame 130.

The cell frame 130 according to the present embodiment can be formed by injection molding, and during injection molding, the above-mentioned diffuse reflection pattern 190 may be simultaneously formed on the surface of the cell frame 130.

Due to the diffuse reflection pattern 190 formed on the surface of the cell frame 130 according to the present embodiment, the curing time of the photocurable resin for fixing the battery cell 110 to the bottom plate 120 can be significantly reduced.

Meanwhile, one or more battery modules according to one embodiment of the present disclosure can be packaged in a pack case to form a battery pack. The battery module and the battery pack including the same as set forth above can be applied to various devices. Such a device can be applied to a vehicle means such as an electric bicycle, an electric vehicle, or a hybrid vehicle, but the present disclosure is not limited thereto, and is applicable to various devices that can use a battery module and a battery pack including the same.

Although preferred embodiments of the present disclosure have been described in detail above, the scope of the present disclosure is not limited thereto, and various modifications and improvements can be made by those skilled in the art using the basic concepts of the present disclosure as defined in the appended claims, which also falls within the scope of the present disclosure.

[Description of Reference Numerals]

| | |
|---|---|
| 100: battery module | 10: battery cell |
| 120: bottom plate | 130: cell frame |
| 130h: hole | 140: adhesive layer |
| 160: chamber | 170: light source unit |
| 190: diffuse reflection pattern | |

1. A battery module, comprising:
a bottom plate;
a cell frame located on the bottom plate;
a plurality of battery cells mounted to the cell frame; and
an adhesive layer located between the bottom plate and the plurality of battery cells,
wherein the cell frame has light transmittance.

2. The battery module according to claim 1, wherein:
the adhesive layer is formed of a photocurable resin.

3. The battery module according to claim 1, wherein:
the cell frame is formed with a plurality of holes for mounting the plurality of battery cells.

4. The battery module according to claim 3, wherein:
the adhesive layer is formed in the plurality of holes and contacts at least one of the bottom plate and a bottom portion of one of the plurality of battery cells.

5. The battery module according to claim 1, wherein:
the cell frame is formed of a resin for generating total internal reflection into the cell frame.

6. The battery module according to claim 5, wherein:
the resin has a transmittance of 90% or more.

7. The battery module according to claim 1, further comprising:
a diffuse reflection member formed on a part of the a surface of the cell frame.

8. The battery module according to claim 7, wherein:
the diffuse reflection member is formed on a boundary surface between the cell frame and the adhesive layer.

9. The battery module according to claim 7, wherein:
the battery module is configured to cause a light entering the cell frame to pass through the diffuse reflection member and to be emitted to the adhesive layer, so that the adhesive layer is photo-cured.

10. The battery module according to claim 1, wherein:
the adhesive layer includes a photocuring initiator.

11. The battery module according to claim 1, wherein:
the bottom plate is a cooling plate.

12. The battery module according to claim 1, wherein:
each of the plurality of battery cells is cylindrical.

13. The battery module according to claim 1, wherein:
the bottom plate and the cell frame are integrally formed.

14. The battery module according to claim 1, wherein:
a plurality of light paths are formed inside the cell frame.

15. A battery pack comprising the battery module as set forth in claim 1.
